(19) United States
(12) Patent Application Publication
(10) Pub. No.: US 2018/0180979 A1
(43) Pub. Date: Jun. 28, 2018

(54) PROJECTION DEVICE AND PROJECTION SYSTEM

(71) Applicant: Shenzhen China Star Optoelectronics Technology Co., Ltd., Shenzhen (CN)

(72) Inventor: Xiangyang XU, Shenzhen (CN)

(73) Assignee: SHENZHEN CHINA STAR OPTOELECTRONICS TECHNOLOGY CO., LTD., Shenzhen (CN)

(21) Appl. No.: 15/305,244

(22) PCT Filed: Jun. 30, 2016
(86) PCT No.: PCT/CN2016/087804

§ 371 Date: Oct. 19, 2016

(30) Foreign Application Priority Data
May 31, 2016 (CN) 201610377500.6

(51) Int. Cl. G03B 21/20; G03B 33/12; G03B 21/00; G03B 21/602; G03B 21/604

(52) U.S. Cl. CPC G03B 21/2073; G03B 21/2013; G03B 33/12; G03B 21/008; G03B 21/006; G03B 21/604; G03B 21/2033; G03B 21/208; G03B 21/602

(57) ABSTRACT

A projection device and a projection system are provided. The projection device has: a light source module; a polarizing element configured to output a linearly polarized light with a predefined polarizing direction according to a light emitted from the light source module; a modulating module configured to modulate the linearly polarized light into an object image, wherein the polarizing element is disposed between the modulating module and the light source module; and a projection lens configured to project the object image onto a screen. An advantage of the projection device is to increase a contrast of the projected image.

### FIELD OF THE INVENTION

The present invention relates to a technical field of displays, and more particularly to a projection device and a projection system.

### BACKGROUND OF THE INVENTION

With the developments of science technology and economic level, in various teaching or speech rooms, using a projector has been very popular.

The projector now is a common office article, and the displaying principle thereof is to project an image on a screen through a light machine. However, when the screen needs to display black pixels, because it suffers an interruption from external ambient lights, which will emit on these pixels, these pixels cannot be displayed as a pure black. Thus, a big defect of a traditional projecting display is that the projected image has a low contrast.

### SUMMARY OF THE INVENTION

The object of the present invention is to provide a projection device and a projection system, so as to solve a problem that: in a traditional projection device and projection system, a contrast of an image is not good enough.

For solving the above-mentioned problem, the present invention provides technical solutions as follows:

The present invention provides a projection device, which comprises:

a light source module;
a polarizing element configured to output a linearly polarized light with a predefined polarizing direction according to a light emitted from the light source module;
a modulating module configured to modulate the linearly polarized light into an object image, wherein the polarizing element is disposed between the modulating module and the light source module; and
a projection lens configured to project the object image onto a screen.

In the projection device according to the present invention, the light source module includes at least three single-color light source modules, and the modulating module includes:

at least three liquid crystal panels, wherein each of the liquid crystal panels corresponds with one of the single-color light source modules, respectively, and the liquid crystal panel is configured to modulate the light emitted from the corresponding single-color light source module into a single-color image; and
a beam combining mirror configured to combine the three single-color images into the object image.

In the projection device according to the present invention, the numbers of the single-color light source modules and the liquid crystal panels are both three, and the at least three single-color light source modules include a red light source module, a blue light source module, and a green light source module, respectively.

In the projection device according to the present invention, the polarizing element includes at least three light-polarizing sheets, and each of the light-polarizing sheets is attached to a surface of the liquid crystal panels which is toward the single-color light source module, respectively.

In the projection device according to the present invention, the modulating module is a DMD (digital micromirror device) chip; the light source module includes a light source and a beam shaping device; the polarizing element includes a polarizing transferring device; the beam shaping device is disposed between the light source and the polarizing transferring device; the light emitted from the light source is shaped through the beam shaping device, and then emitted into the polarizing transferring device, and through the polarizing transferring device, the light is transferred into a linearly polarized light along a predefined shaking direction; and the polarizing transferring device emits the linearly polarized light into the DMD chip, and through the DMD chip, the linearly polarized light is modulated into the object image, which is reflected into the projection lens to form a projection.

The present invention further provides a projection system, which comprises: a projection device and a screen, wherein the screen comprises:

a Fresnel screen; and
a polarizing screen, wherein the Fresnel screen is attached to the polarizing screen;
wherein the projection device comprises:
a light source module;
a polarizing element configured to output a linearly polarized light with a predefined polarizing direction according to a light emitted from the light source module;
a modulating module configured to modulate the linearly polarized light into an object image, wherein the polarizing element is disposed between the modulating module and the light source module; and
a projection lens configured to project the object image onto a screen.

In the projection system according to the present invention, the light source module includes at least three single-color light source modules; and

the modulating module includes:
at least three liquid crystal panels, wherein each of the liquid crystal panels corresponds with one of the single-color light source modules, respectively, and the liquid crystal panel is configured to modulate the light emitted from the corresponding single-color light source module into a single-color image; and
a beam combining mirror configured to combine the three single-color images into the object image.

In the projection system according to the present invention, the numbers of the single-color light source modules and the liquid crystal panels are both three, and the at least three single-color light source modules include a red light source module, a blue light source module, and a green light source module, respectively.

In the projection system according to the present invention, the polarizing element includes at least three light-polarizing sheets, and each of the light-polarizing sheets is attached to a surface of the liquid crystal panels which is toward the single-color light source module, respectively.

In the projection system according to the present invention, the modulating module is a DMD (digital micromirror device) chip; the light source module includes a light source and a beam shaping device; the polarizing element includes a polarizing transferring device; the beam shaping device is disposed between the light source and the polarizing transferring device; the light emitted from the light source is shaped through the beam shaping device, and then emitted into the polarizing transferring device, and through the polarizing transferring device, the light is transferred into a linearly polarized light along a predefined shaking direction; and the polarizing transferring device emits the linearly polarized light into the DMD chip, and through the DMD chip, the linearly polarized light is modulated into the object image, which is reflected into the projection lens to form a projection.

Comparing the present invention with the traditional technology, the projection device according to the present invention can filter out an ambient natural light under the help of the polarizing element, so as to increase the contrast of the projected image.

### DESCRIPTION OF THE DRAWINGS

FIG. 1 is a schematic structural view of a projection device according to a first preferred embodiment of the present invention;

FIG. 2 is a schematic structural view of a projection device according to a second preferred embodiment of the present invention;

FIG. 3 is a schematic structural view of a projection system according to a first preferred embodiment of the present invention; and

FIG. 4 is a schematic structural view of a projection system according to a second preferred embodiment of the present invention.

### DETAILED DESCRIPTION OF THE PREFERRED EMBODIMENTS

The foregoing objects, features, and advantages adopted by the present invention can be best understood by referring to the following detailed description of the preferred embodiments and the accompanying drawings. Furthermore, the directional terms described in the present invention, such as upper, lower, front, rear, left, right, inside, outer, side, etc., are only directions with reference to the accompanying drawings, so that the used directional terms are used to describe and understand the present invention, but the present invention is not limited thereto.

In the drawings, units with similar structures use the same numerals.

The present invention provides a projection device, which comprises:

a light source module;
a polarizing element configured to output a linearly polarized light with a predefined polarizing direction according to a light emitted from the light source module;
a modulating module configured to modulate the linearly polarized light into an object image, wherein the polarizing element is disposed between the modulating module and the light source module; and
a projection lens configured to project the object image onto a screen.

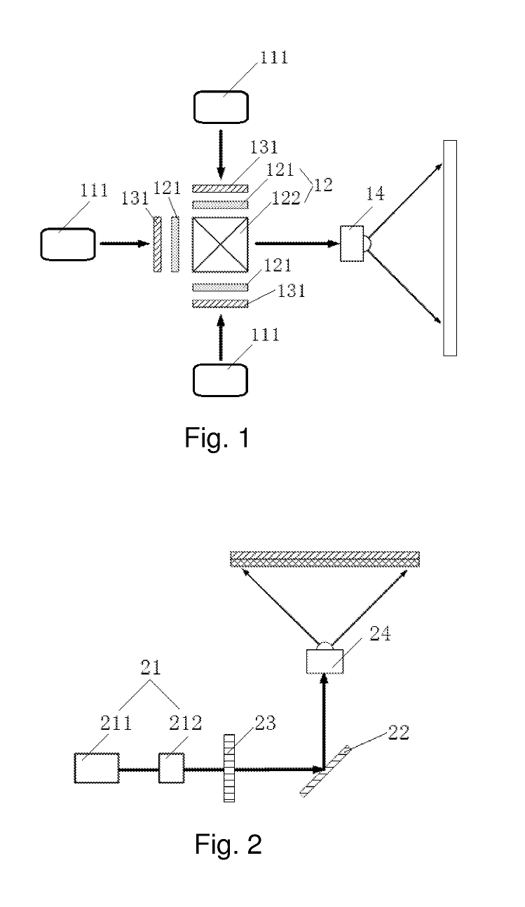

Refer now to FIG. 1, which is a schematic structural view of a projection device according to a first preferred embodiment of the present invention. The projection device comprises a light source module (not labeled), a modulating module 12, a polarizing element (not labeled), and a projection lens 14. The polarizing element is disposed between the light source module and the modulating module 12, and is configured to output a linearly polarized light with a single polarizing direction according to a light emitted from the light source module and filtered out an ambient light. The modulating module 12 is configured to modulate the polarized light into an object image. The projection lens 14 is configured to project the object image onto a screen.

Specifically, the light source module includes at least three single-color light source modules 111. In the embodiment, the light source module includes three of the single-color light source modules 111, which are a green light source module, a red light source module, and a blue light source module, respectively. Each of the single-color light source modules 111 is a laser light source. It can be understood that the number of the single-color light source modules 111 can also be four, which are two blue light source modules, a red light source module, and a green light source module, respectively.

The modulating module 12 includes at least three liquid crystal panels 121 and a beam combining mirror 122. Each of the liquid crystal panels 121 corresponds with one of the single-color light source modules 111, respectively. A light emitted from the single-color light source module 111 is modulated into a single-color image through a process of the polarizing element. The beam combining mirror 122 is configured to combine the three single-color images into an object image. The liquid crystal panel 121 can be a liquid crystal display (LCD) chip or a liquid crystal on silicon (LCOS) chip.

The polarizing element includes at least three light-polarizing sheets 131. The at least three light-polarizing sheets 131 correspond with the at least three liquid crystal panels 121, respectively, and each of the light-polarizing sheets 131 is attached to a surface of the liquid crystal panels 121 which is toward the single-color light source module 111, respectively.

It can be understood that the projection device further comprises a shell body (not shown). The shell body is provided with an open end, wherein the light source module, the modulating module 12, and the polarizing element are all disposed inside the shell body, and the projection lens 14 is disposed at the open end of the shell body.

From the above description it will be appreciated that: the projection device of the embodiment can filter out an ambient natural light through the polarizing element, so as to increase a contrast of the projected image. Additionally, because it uses a method in which a light emitted from the single-color light source module is filtered out the ambient light and modulated into a single-color image, respectively, and then a plurality of the single-color images are combined into an object image by using the beam combining mirror, the light-polarizing sheet can be disposed according to the polarizing direction of the single-color light source, so that it can better filter out the ambient light, and has an effect for further increasing the contrast of the projected image.

Refer now to FIG. 2, which is a schematic structural view of a projection device according to a second preferred embodiment of the present invention. The projection device comprises a light source module 21, a modulating module 22, a polarizing element 23, and a projection lens 24. The polarizing element 23 is disposed between the light source module 21 and the modulating module 22, and is configured to transfer a light emitted from the light source module 21 into a linearly polarized light with a predefined polarizing direction. The modulating module 22 is configured to modulate the linearly polarized light into an object image. The projection lens 24 is configured to project the object image onto a screen.

Specifically, the modulating module 22 includes a digital micromirror device (DMD) chip. The DMD chip is micromirror switches, by which a light emitted therefrom is a nonlinearly polarized light. The light source module 21 includes a light source 211 and a beam shaping device 212, wherein a light emitted from the light source 211 is emitted into the beam shaping device 212 to be shape-processed.

The polarizing element 23 is a polarizing transferring device. The beam shaping device 212 is disposed between the light source 211 and the polarizing element 23. The light emitted from the light source is shaped through the beam shaping device 212, and then emitted into the polarizing transferring device, and through the polarizing transferring device, the light is transferred into a linearly polarized light along a predefined shaking direction. The polarizing transferring device emits the linearly polarized light into the DMD chip, and through the DMD chip, the linearly polarized light is modulated into an object image, which is reflected into the projection lens 24 to form a projection.

In the polarizing transferring device, incident lights are emitted into the polarizing transferring device, wherein the incident lights can be naturally polarized lights, elliptically polarized lights, or circularly polarized lights. The incident lights are emitted on a polarized beam splitter of the polarizing transferring device, in which s-polarized lights are reflected, and p-polarized lights are projected. The reflected s-polarized lights are emitted into an adjacent polarized beam splitter to be reflected again, and the p-polarized lights pass through the polarized beam splitter are transferred into s-polarized lights via a ½ glass slide, so that the naturally polarized lights, the elliptically polarized lights, or the circularly polarized lights are transferred into linearly polarized lights with a predefined polarizing direction.

It can be understood that a polarized film can be further attached to an emergent surface of the polarizing transferring device, and a polarizing direction of the polarized film is the same as a polarizing direction of an emergent light.

Specifically, the emitting method of the light source is periodic, wherein in each period, the light source emits a red light, a green light, and a blue light by order. A maintaining time of each of the color lights is the same, and the total maintaining time is less than 100 ms (microseconds). Because the human eye has a persistence of vision characteristic, it can see a frame of image through a projection of the projection lens.

From the above description it will be appreciated that: the projection device of the embodiment can transfer a light emitted from the light source into a linearly polarized light with a single polarizing direction through the polarizing element, so as to absorb an ambient light with a different polarizing direction thereafter, so that a contrast of the projected image is increased.

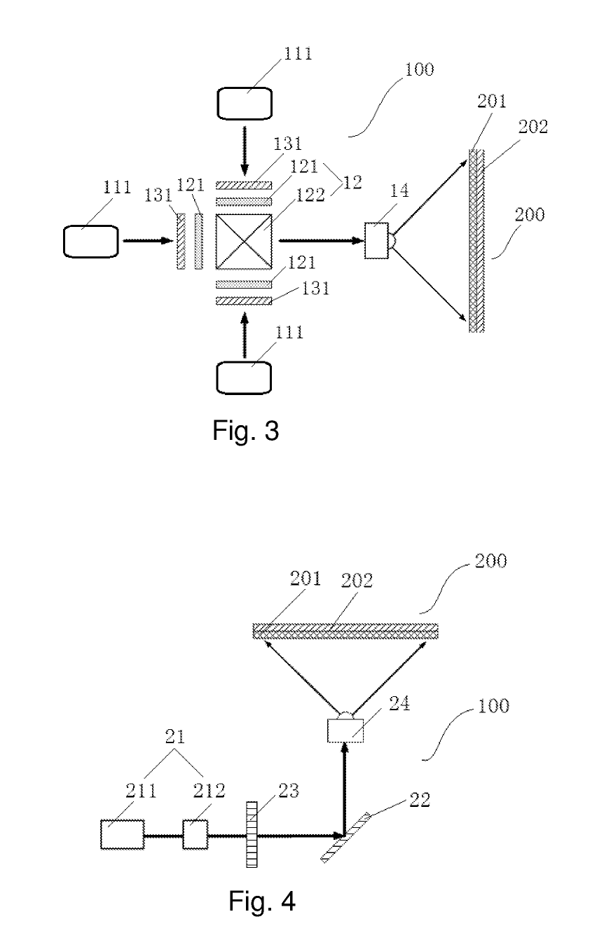

Refer now to FIG. 3, which is a schematic structural view of a projection system according to a first preferred embodiment of the present invention. The projection system comprises a projection device 100 and a screen 200.

The projection device comprises a light source module (not labeled), a modulating module 12, a polarizing element (not labeled), and a projection lens 14. The polarizing element is disposed between the light source module and the modulating module 12, and is configured to output a linearly polarized light with a single polarizing direction according to a light emitted from the light source module and filtered out an ambient light. The modulating module 12 is configured to modulate the polarized light into an object image. The projection lens 14 is configured to project the object image onto a screen.

The screen 200 includes: a Fresnel screen 201 and a polarizing screen 202. The Fresnel screen 201 is attached to the polarizing screen 202. A polarizing direction of the polarizing screen 202 is the same as a polarizing direction of the polarizing element.

Specifically, the light source module includes at least three single-color light source modules 111. In the embodiment, the light source module includes three of the single-color light source modules 111, which are a green light source module, a red light source module, and a blue light source module, respectively. Each of the single-color light source modules 111 is a laser light source. It can be understood that the number of the single-color light source modules 111 can also be four, which are two blue light source modules, a red light source module, and a green light source module, respectively.

The modulating module 12 includes at least three liquid crystal panels 121 and a beam combining mirror 122. Each of the liquid crystal panels 121 corresponds with one of the single-color light source modules 111, respectively. A light emitted from the single-color light source module 111 is modulated into a single-color image through a process of the polarizing element. The beam combining mirror 122 is configured to combine the three single-color images into an object image. The liquid crystal panel 121 can be a liquid crystal display (LCD) chip or a liquid crystal on silicon (LCOS) chip.

The polarizing element includes at least three light-polarizing sheets 131. The at least three light-polarizing sheets 131 correspond with the at least three liquid crystal panels 121, respectively, and each of the light-polarizing sheets 131 is attached to a surface of the liquid crystal panels 121 which is toward the single-color light source module 111, respectively.

It can be understood that the projection device further comprises a shell body (not shown). The shell body is provided with an open end, wherein the light source module, the modulating module 12, and the polarizing element are all disposed inside the shell body, and the projection lens 14 is disposed at the open end of the shell body.

From the above description it will be appreciated that: the projection system according to the present invention can filter out an ambient with a different polarizing direction from the corresponding single-color light through the polarizing sheets, and the polarizing screen can further filter out different polarizations from the single-color light. After that, because the Fresnel screen only reflects a light with a particular angle (in the present invention, it only reflects the light projected from the projection lens), and because the incident angles of the ambient light are chaos, the Fresnel screen can shield most of the ambient light, and then the polarizing screen can further shield some of the ambient light, so that a contrast of the projected image is increased.

Refer now to FIG. 4, which is a schematic structural view of a projection system according to a second preferred embodiment of the present invention. The projection system comprises a projection device 100 and a screen 200.

The projection device comprises a light source module 21, a modulating module 22, a polarizing element 23, and a projection lens 24. The polarizing element 23 is disposed between the light source module 21 and the modulating module 22, and is configured to transfer a light emitted from the light source module 21 into a linearly polarized light with a predefined polarizing direction. The modulating module 22 is configured to modulate the linearly polarized light into an object image. The projection lens 24 is configured to project the object image onto a screen.

The screen 200 includes: a Fresnel screen 201 and a polarizing screen 202. The Fresnel screen 201 is attached to the polarizing screen 202. A polarizing direction of the polarizing screen 202 is the same as a polarizing direction of the polarizing element.

Specifically, the modulating module 22 includes a digital micromirror device (DMD) chip. The DMD chip is a micromirror switches, by which a light emitted therefrom is a nonlinearly polarized light. The light source module 21 includes a light source 211 and a beam shaping device 212, wherein a light emitted from the light source 211 is emitted into the beam shaping device 212 to be shape-processed.

The polarizing element 23 is a polarizing transferring device. The beam shaping device 212 is disposed between the light source 211 and the polarizing element 23. The light emitted from the light source is shaped through the beam shaping device 212, and then emitted into the polarizing transferring device, and through the polarizing transferring device, the light is transferred into a linearly polarized light along a predefined shaking direction. The polarizing transferring device emits the linearly polarized light into the DMD chip, and through the DMD chip, the linearly polarized light is modulated into an object image, which is reflected into the projection lens 24 to form a projection. It can be understood that a polarized film can be further attached to an emergent surface of the polarizing transferring device, and a polarizing direction of the polarized film is the same as a polarizing direction of an emergent light.

Specifically, the emitting method of the light source is periodic, wherein in each period, the light source emits a red light, a green light, and a blue light by order. A maintaining time of each of the color lights is the same, and the total maintaining time is less than 100 ms (microseconds). Because the human eye has a persistence of vision characteristic, it can see a frame of image through a projection of the projection lens.

From the above description it will be appreciated that: the projection system of the embodiment can transfer a light emitted from the light source into a linearly polarized light with a single polarizing direction through the polarizing element. After that, through the polarizing screen, an ambient with a different polarizing direction from that of the polarizing transferring device is absorbed, so as to increase a contrast of the projected image. Additionally, because the incident angles of the ambient light are chaos, the Fresnel screen can shield most of the ambient light, so as to further increase the contrast of the projected image.

The present invention has been described with preferred embodiments thereof and it is understood that many changes and modifications to the described embodiment can be carried out without departing from the scope and the spirit of the invention that is intended to be limited only by the appended claims.

What is claimed is:

1. A projection device, comprising:
a light source module;
a polarizing element configured to output a linearly polarized light with a predefined polarizing direction according to a light emitted from the light source module;
a modulating module configured to modulate the linearly polarized light into an object image, wherein the polarizing element is disposed between the modulating module and the light source module; and
a projection lens configured to project the object image onto a screen.

2. The projection device according to claim 1, wherein the light source module includes at least three single-color light source modules, and the modulating module includes:
at least three liquid crystal panels, wherein each of the liquid crystal panels corresponds with one of the single-color light source modules, respectively, and the liquid crystal panel is configured to modulate the light emitted from the corresponding single-color light source module into a single-color image; and
a beam combining mirror configured to combine the three single-color images into the object image.

3. The projection device according to claim 2, wherein the numbers of the single-color light source modules and the liquid crystal panels are both three, and the at least three single-color light source modules include a red light source module, a blue light source module, and a green light source module, respectively.

4. The projection device according to claim 2, wherein the polarizing element includes at least three light-polarizing sheets, and each of the light-polarizing sheets is attached to a surface of the liquid crystal panels which is toward the single-color light source module, respectively.

5. The projection device according to claim 1, wherein the modulating module is a DMD (digital micromirror device) chip; the light source module includes a light source and a beam shaping device; the polarizing element includes a polarizing transferring device; the beam shaping device is disposed between the light source and the polarizing transferring device; the light emitted from the light source is shaped through the beam shaping device, and then emitted into the polarizing transferring device, and through the polarizing transferring device, the light is transferred into a linearly polarized light along a predefined shaking direction; and the polarizing transferring device emits the linearly polarized light into the DMD chip, and through the DMD chip, the linearly polarized light is modulated into the object image, which is reflected into the projection lens to form a projection.

6. A projection system, comprising a projection device and a screen, wherein the screen comprises:
a Fresnel screen; and
a polarizing screen, wherein the Fresnel screen is attached to the polarizing screen;
wherein the projection device comprises:
a light source module;
a polarizing element configured to output a linearly polarized light with a predefined polarizing direction according to a light emitted from the light source module;
a modulating module configured to modulate the linearly polarized light into an object image, wherein the polarizing element is disposed between the modulating module and the light source module; and
a projection lens configured to project the object image onto a screen.

7. The projection system according to claim 6, wherein the light source module includes at least three single-color light source modules; and
the modulating module includes:
at least three liquid crystal panels, wherein each of the liquid crystal panels corresponds with one of the single-color light source modules, respectively, and the liquid crystal panel is configured to modulate the light emitted from the corresponding single-color light source module into a single-color image; and
a beam combining mirror configured to combine the three single-color images into the object image.

8. The projection system according to claim 7, wherein the numbers of the single-color light source modules and the liquid crystal panels are both three, and the at least three single-color light source modules include a red light source module, a blue light source module, and a green light source module, respectively.

9. The projection system according to claim 7, wherein the polarizing element includes at least three light-polarizing sheets, and each of the light-polarizing sheets is attached to a surface of the liquid crystal panels which is toward the single-color light source module, respectively.

10. The projection system according to claim 6, wherein the modulating module is a DMD (digital micromirror device) chip; the light source module includes a light source and a beam shaping device; the polarizing element includes a polarizing transferring device; the beam shaping device is disposed between the light source and the polarizing transferring device; the light emitted from the light source is shaped through the beam shaping device, and then emitted into the polarizing transferring device, and through the polarizing transferring device, the light is transferred into a linearly polarized light along a predefined shaking direction; and the polarizing transferring device emits the linearly polarized light into the DMD chip, and through the DMD chip, the linearly polarized light is modulated into the object image, which is reflected into the projection lens to form a projection.

11. A projection system, comprising a projection device and a screen, wherein the screen comprises:
a Fresnel screen; and
a polarizing screen, wherein the Fresnel screen is attached to the polarizing screen;
wherein the projection device comprises:
a light source module;
a polarizing element configured to output a linearly polarized light with a predefined polarizing direction according to a light emitted from the light source module;
a modulating module configured to modulate the linearly polarized light into an object image, wherein the polarizing element is disposed between the modulating module and the light source module; and
a projection lens configured to project the object image onto a screen;
wherein the light source module includes at least three single-color light source modules; and
the modulating module includes:
at least three liquid crystal panels, wherein each of the liquid crystal panels corresponds with one of the single-color light source modules, respectively, and the liquid crystal panel is configured to modulate the light emitted from the corresponding single-color light source module into a single-color image; and
a beam combining mirror configured to combine the three single-color images into the object image;
wherein the polarizing element includes at least three light-polarizing sheets, and each of the light-polarizing sheets is attached to a surface of the liquid crystal panels which is toward the single-color light source module, respectively.
